(19) United States
(12) Patent Application Publication
(10) Pub. No.: US 2026/0367561 A1
(43) Pub. Date: Nov. 19, 2026

(54) INSPECTION APPARATUS FOR PRINTED MATTER, INSPECTION METHOD FOR PRINTED MATTER, AND STORAGE MEDIUM STORING INSPECTION PROGRAM FOR PRINTED MATTER

(71) Applicant: CANON KABUSHIKI KAISHA, Tokyo (JP)

(72) Inventor: KAZUO WAKAI, Tokyo (JP)

(21) Appl. No.: 19/671,542

(22) Filed: May 8, 2026

(30) Foreign Application Priority Data
May 14, 2025 (JP) 2025-081447

(51) Int. Cl. G03G 15/00

(52) U.S. Cl. CPC G03G 15/5062; G03G 15/5016; G03G 15/55

(57) ABSTRACT

An inspection apparatus that enables efficiency improvement of the inspection setting operation. The inspection apparatus inspects a printing state of printed matter obtained by printing document data. The inspection apparatus includes a scanner configured to scan the printed matter and generate a scanned image, a memory device that stores a set of instructions, and at least one processor that executes the set of instructions to obtain presets each of which includes a combination of an area to be inspected in the scanned image and an inspection content, receive a selection of a preset to be used for inspection of the scanned image from among the presets obtained, and execute inspection of the scanned image according to the preset selected.

### BACKGROUND

### Field of the Technology

The aspect of the embodiments relates to an inspection apparatus for printed matter, an inspection method for printed matter, and a storage medium storing an inspection program for printed matter.

### Description of the Related Art

Conventionally, print quality of printed matter has been generally confirmed by visual inspection. In recent years, an inspection apparatus that automatically performs inspection in a post-processing of a printer has been known. In the inspection apparatus, document data is registered as image data that serves as a correct answer. The inspection apparatus scans printed matter that prints the document data. The inspection apparatus detects an abnormality in print quality of the printed matter by comparing the read image data and the document data. Regarding such an inspection apparatus, a technology has been proposed that can efficiently achieve an inspection setting operation by registering an inspection target that is included in the image data in advance (see Japanese Patent Laid-Open Publication No. 2024-9624).

### SUMMARY

The present disclosure provides a mechanism that enables efficiency improvement of the inspection setting operation.

Accordingly, an aspect of the embodiments provides an inspection apparatus that inspects a printing state of printed matter obtained by printing document data. The inspection apparatus includes a scanner configured to scan the printed matter and generate a scanned image, a memory device that stores a set of instructions, and at least one processor that executes the set of instructions to obtain presets each of which includes a combination of an area to be inspected in the scanned image and an inspection content, receive a selection of a preset to be used for inspection of the scanned image from among the presets obtained, and execute inspection of the scanned image according to the preset selected.

Features of the present disclosure will become apparent from the following description of embodiments with reference to the attached drawings. The following description of embodiments is described by way of example.

### BRIEF DESCRIPTION OF THE DRAWINGS

FIG. 1 is a system configuration diagram illustrating an inspection system according to a first embodiment.

FIG. 2 is a block diagram illustrating a configuration of an image forming apparatus according to the first embodiment.

FIG. 3 is a block diagram illustrating an inspection apparatus according to the first embodiment.

FIG. 4 is a flowchart illustrating an overall flow of an inspection process according to the first embodiment.

FIGS. 5A-5C are schematic diagrams illustrating tables of job presets and page presets according to the first embodiment.

FIG. 6 is a view illustrating a screen displayed in an inspection setting according to the first embodiment.

FIG. 7 is a flowchart illustrating a flow of an inspection setting process that uses the page preset according to the first embodiment.

FIGS. 8A and 8B are views illustrating screens to set preset names according to the first embodiment.

FIG. 9 is a flowchart illustrating a flow of manually executing the inspection setting in a step S611 in FIG. 7.

FIG. 10 is a flowchart illustrating a flow of an inspection execution process in a step S404 in FIG. 4.

FIG. 11 is a flowchart illustrating a flow of a group page preset setting process and a registration process according to a second embodiment.

FIG. 12 is a view illustrating a screen displayed in the inspection setting according to the second embodiment.

FIG. 13 is a schematic diagram illustrating a storage table of the group page presets according to the second embodiment.

FIGS. 14A and 14B are views illustrating screens displayed when the group page preset is set and registered according to the second embodiment.

FIG. 15 is a flowchart illustrating a flow of a group page preset application process according to the second embodiment.

FIG. 16 is a view illustrating a screen to which a page preset according to a third embodiment is applied.

### DESCRIPTION OF THE EMBODIMENTS

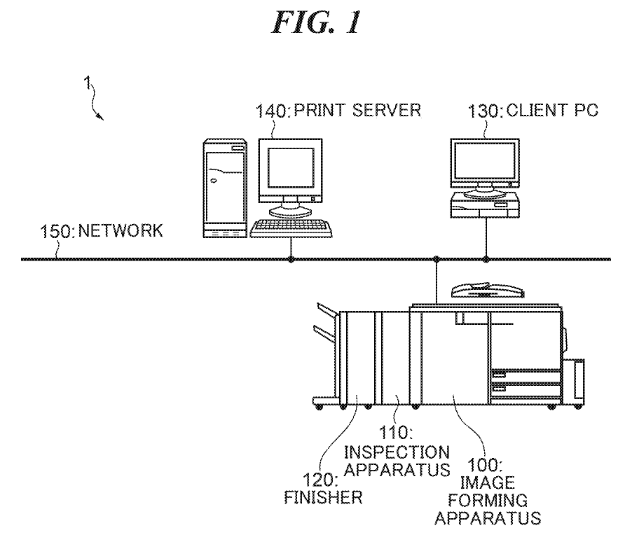

Hereinafter, embodiments of an inspection apparatus, an inspection method, and an inspection program of the present disclosure will be described in detail with reference to FIGS. 1-16. However, components described in these embodiments are merely examples, and the scope of the present invention is not intended to be limited to these.

FIG. 1 is an overall configuration diagram of a system 1 that includes an inspection apparatus 110 according to a first embodiment. The system 1 includes an image forming apparatus 100, the inspection apparatus 110, a finisher 120, a client PC 130, a print server 140, and a network 150. The image forming apparatus 100 executes printing based on various types of input data. The image forming apparatus 100 executes printing based on, for example, print data (an example of document data) that is sent from the client PC 130 or the print server 140.

The inspection apparatus 110 inspects a printing state of printed matter that prints the print data. The printed matter includes one or more printed sheets. The inspection apparatus 110 receives the printed matter that is output from the image forming apparatus 100. The inspection apparatus 110 inspects whether an abnormal image exists in the received printed matter. Here, the abnormal image is an image that degrades quality of the printed matter. The abnormal image is, for example, a stain due to adhesion of coloring material to an unintended location when printing is performed. Further, the abnormal image is, for example, missing color due to insufficient adhesion of the coloring material to an intended location.

The finisher 120 receives the printed matter (printed sheet) that is inspected by the inspection apparatus 110. The finisher 120 switches a sheet discharge destination of the printed sheet based on an inspection result of the inspection apparatus 110. The finisher 120 achieves a post-processing as needed. The post-processing is, for example, book binding. The finisher 120 discharges the printed sheet to which the post-processing has been applied. The image forming apparatus 100 is connected to the client PC 130 and the print server 140 via the network 150. Further, the image forming apparatus 100 is connected to the inspection apparatus 110 and the finisher 120 via a communication cable. Note that the inspection apparatus 110 is connected to the finisher 120 via the communication cable in addition to the image forming apparatus 100. In the present embodiment, an inline inspection machine that consistently performs image formation, inspection, the post-processing, and paper discharge is shown as the image forming apparatus 100, the inspection apparatus 110, and the finisher 120.

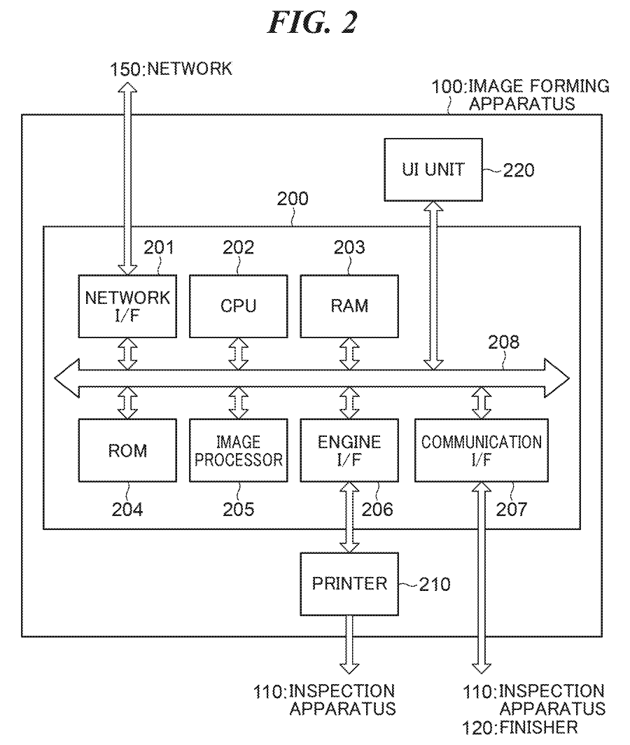

FIG. 2 is a block diagram illustrating a configuration of the image forming apparatus 100 according to the present embodiment. The image forming apparatus 100 includes a controller 200, a printer 210, and a UI unit 220. The controller 200 receives an image or a document via the network 150. The controller 200 converts a received image or document into print data. The printer 210 prints the print data on a paper sheet. The controller 200 includes a network I/F (interface) 201, a CPU 202, a RAM 203, and a ROM 204. Further, the controller 200 includes an image processor 205, an engine I/F 206, a communication I/F 207, and an internal bus (system bus )208.

The network I/F 201 controls transmission and reception of data via the network 150. The CPU 202 controls the entire image forming apparatus 100. The RAM 203 is used as a work area of the CPU 202 when various types of instructions are executed. The ROM 204 stores program data executed by the CPU 202 and setting data of the controller 200. The image processor 205 converts image data or document data received via the network 150 into the print data. The image processor 205 executes, for example, an RIP process (Raster Image Processing). Further, the image processor 205 executes the RIP process for converting the image data or the document data received via the network 150 into correct answer image data. Note that the correct answer image data is image data of a document that serves as a comparison target that is used when the printed matter is inspected. In the RIP process for the correct answer image data, for example, the image data or the document data with a resolution of 600 dpi is converted to 300 dpi to generate the correct answer image data. In the RIP process for the print data, the image data is generated without lowering the resolution.

The engine I/F 206 transmits the print data to the printer 210. The communication I/F 207 communicates with the inspection apparatus 110 and the finisher 120. The communication I/F 207 is connected to the internal bus 208. The printer 210 generates the printed matter by printing. The UI unit 220 receives selection of sheet information from a user.

The client PC 130 or the print server 140 on the network 150 generates image data or the document data. The created image data or document data is converted into PDL data. The PDL data is transmitted to the image forming apparatus 100 via a network (for example, a Local Area Network). The transmitted PDL data is stored in the RAM 203 via the network I/F 201. Further, a print instruction by the user input to the UI unit 220 is stored in the RAM 203 through the internal bus 208. The print instruction by the user includes, for example, selection of a sheet type.

The image processor 205 obtains the PDL data stored in the RAM 203. The image processor 205 converts the PDL data into the print data. In conversion into the print data, for example, rasterization is executed for the PDL data. The PDL data is converted into multi-valued bitmap data. The multi-valued bitmap data is converted into binary bitmap data for each color by screen processing. The binary bitmap data obtained by the image processor 205 is transmitted to the printer 210 via the engine I/F 206.

The printer 210 prints the received binary bitmap data on a sheet using a coloring material. The CPU 202 issues an instruction to the printer 210 based on the print instruction by the user stored in the RAM 203. The CPU 202 issues the instruction to the printer 210 based on, for example, an instruction from the user to print on a coated sheet. The CPU 202 issues an instruction to the printer 210 to feed a sheet from a paper cassette (not shown) that stores coated sheets in the image forming apparatus 100. The CPU 202 controls various types of processes from reception of the above-described PDL data to printing on the sheet. Thereby, a full-color toner image is formed on the sheet. The sheet on which the full-color toner image is formed is an example of the printed matter.

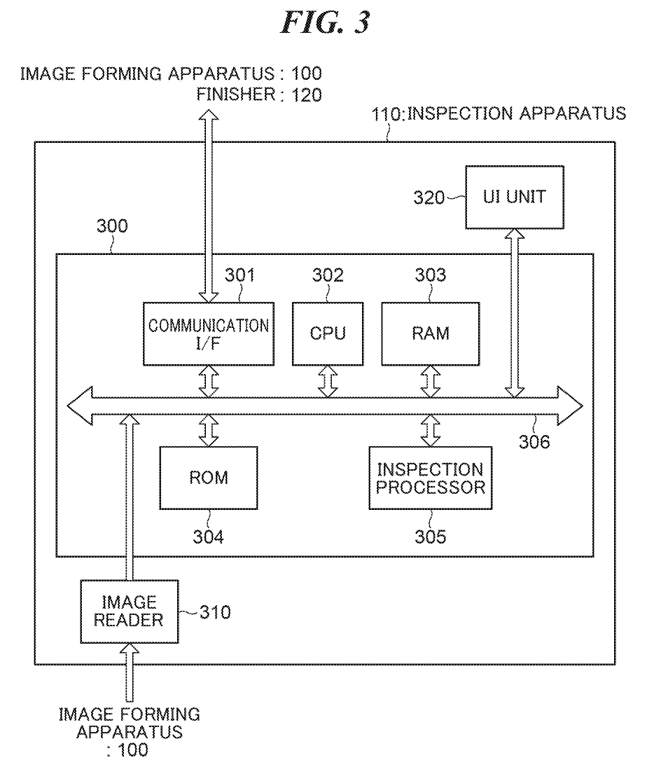

FIG. 3 is a block diagram illustrating a configuration of the inspection apparatus 110. The inspection apparatus 110 includes an inspection controller 300 (an example of an obtaining unit, an inspection execution unit, and a registration unit), an image reader 310 (an example of a reading unit), and a UI unit 320 (an example of a receiving unit and a display unit). The inspection controller 300 controls the entire inspection apparatus 110. The inspection controller 300 inspects whether an abnormal image exists in the printed matter. The inspection controller 300 inspects a variable area portion such as a character string and a barcode. The image reader 310 scans the printed matter conveyed from the image forming apparatus 100. The UI unit 320 receives setting of the inspection apparatus 110 by the user. The UI unit 320 displays an inspection result to the user. Here, the setting of the inspection apparatus 110 performed by the user is setting of an inspection item (an example of an inspection content) that indicates what kind of abnormal image (defect) is to be inspected when the printed matter is inspected. The inspection item is, for example, a round-shaped abnormal image (a spot) or a linear abnormal image (a streak).

The inspection controller 300 includes a communication I/F 301, a CPU 302, a RAM 303, a ROM 304, an inspection processor 305, and an internal bus (system bus) 306. The communication I/F 301 controls data communication with the image forming apparatus 100 and the finisher 120. The CPU 302 controls the entire inspection apparatus 110. The RAM 303 is a work area of the CPU 302 that executes various types of instructions. The ROM 304 stores program data executed by the CPU 302 or setting data of the inspection controller 300. The inspection processor 305 inspects existence of the abnormal image in the printed matter.

Next, an overview of a print image inspection performed by the inspection apparatus 110 is described. The image reader 310 scans the printed matter conveyed from the image forming apparatus 100. The image reader 310 obtains a scanned image of an inspection target. The image reader 310 stores the obtained scanned image of the inspection target in the RAM 303. Then, the inspection processor 305 calculates a difference value between a correct answer image stored in advance in the RAM 303 and the scanned image of the inspection target. Then, the inspection processor 305 compares the calculated difference value with an inspection threshold (contrast and size) of each inspection item for each pixel. The inspection processor 305 stores a comparison result in the RAM 303. The comparison result is, for example, information on existence of the abnormal image in the printed matter. The comparison result is, for example, a type of the detected abnormal image (a spot or a streak). The comparison result is, for example, position information of the abnormal image when displaying on the UI unit 320.

Then, the CPU 302 instructs the UI unit 320 to display the inspection result stored in the RAM 303. The UI unit 320 displays the inspection result. Thereby, the user can recognize the inspection result. When a predetermined number of printed sheets with abnormal images occur continuously, the CPU 302 transmits information indicating that they occur continuously to the image forming apparatus 100 via the communication I/F 301. The information that indicates that they occur continuously is received by the controller 200 via the communication I/F 207. The CPU 202 instructs the printer 210 to stop printing. The printer 210 stops a printing operation in response to the instruction to stop printing.

The CPU 302 also transmits the information to the finisher 120 via the communication I/F 301 based on the inspection result stored in the RAM 303. The information transmitted to the finisher 120 indicates existence of the abnormal image in the printed matter. The finisher 120 sorts the printed sheets using the received information. The finisher 120 discharges the printed sheet that does not include the abnormal image to a normal sheet discharge tray. The finisher 120 discharges the printed sheet that includes the abnormal image to a tray that is different from the normal sheet discharge tray.

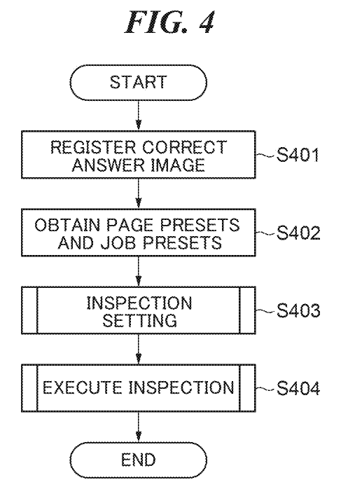

Next, an overall flow from a registration operation before starting inspection to inspection execution in the inspection processor 305 is described using a flowchart shown in FIG. 4. Each process in FIG. 4 is executed by the inspection apparatus 110 in accordance with a user operation from the client PC 130. At this time, a program code stored in the ROM 304 is developed on the RAM 303. The CPU 302 controls the inspection controller 300 using the program code. Note that data created during processing by the inspection apparatus 110 is temporarily stored in the RAM 303 or a storage unit (not shown).

In a step S401, the inspection apparatus 110 registers a correct answer image of the inspection. The inspection apparatus 110 waits in a read mode of the correct answer image. In the client PC 130, a print job for correct answer image registration is executed. When the print job is executed, the inspection apparatus 110 detects conveyance of paper and scans the paper with the image reader 310. The image reader 310 stores the scanned image as the correct answer image in the RAM 303 of the inspection apparatus 110.

Then, in a step S402, the inspection apparatus 110 obtains a plurality of job presets and a plurality of page presets (examples of setting information). Each of the job preset and the page preset includes an inspection area for each correct answer image page that is stored in the storage unit (not shown). Further, each of the job preset and the page preset includes various types of inspection parameters such as inspection levels. The job preset is set in units of jobs. The page preset is set in units of pages.

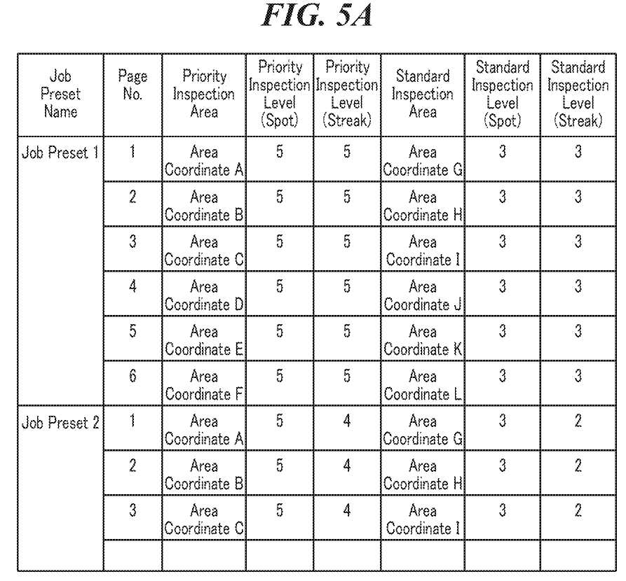

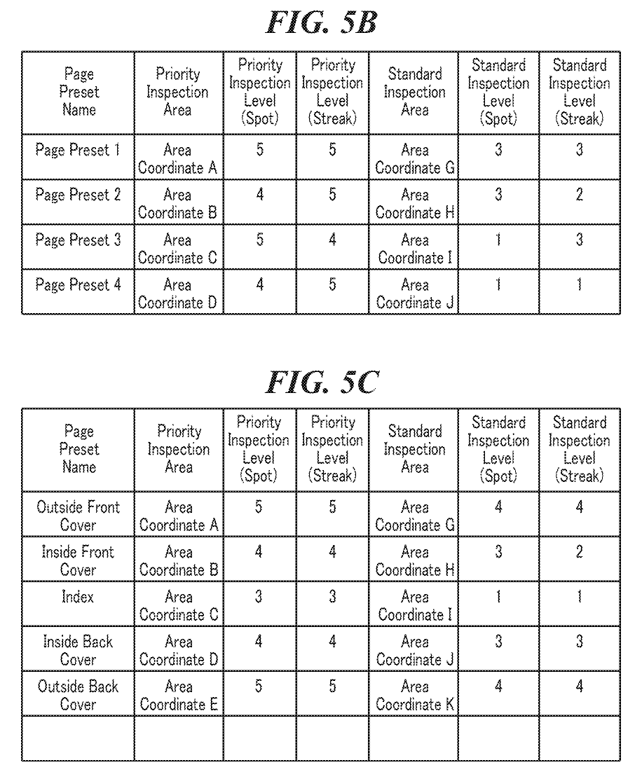

Examples of the job presets and the page presets in the present embodiment will be described using FIGS. 5A-5C. Each of a job preset and a page preset includes a combination of an inspection area where inspection is executed and an inspection item. A job preset table shown in FIG. 5A stores job presets, each of which includes a job preset name, page numbers, priority inspection areas, priority inspection levels for inspection items (a spot and a streak), standard inspection areas, and standard inspection levels for inspection items (a spot and a streak), in units of print jobs. The job preset is linked with the correct answer image page.

Inspections include a priority inspection and a standard inspection. In either of the priority inspection and the standard inspection, an inspection level of a defect to be detected is set according to a type of the defect. The inspection level of the standard inspection is generally set lower than the inspection level of the priority inspection. Coordinates of the standard inspection area may overlap with coordinates of the priority inspection area. When the standard inspection area includes the entire priority inspection area, the priority inspection area is narrower than the standard inspection area.

The job preset name is a set value that serves as a display name when the presets are displayed as a list on a UI 740 described later. The priority inspection levels and the standard inspection levels define detection levels for a spot and a streak set in five stages from level 1 to level 5.

A page preset table shown in FIG. 5B stores page presets, each of which includes a page preset name, a priority inspection area, priority inspection levels for a spot and a streak, a standard inspection area, and standard inspection levels for a spot and a streak, in units of pages. Inspections include the priority inspection and the standard inspection. An inspection level of a defect to be detected may be changed according to the type of the inspection. The page preset name is a set value that serves as a display name when the page presets are displayed as a list on the UI 740 described later.

Returning to FIG. 4, the inspection setting is performed in a step S403. That is, the inspection apparatus 110 sets various types of inspection parameters such as an inspection area and an inspection level in accordance with an inspection setting operation by the user. Then, in a step S404, the inspection apparatus 110 receives the print job for the inspection from the client PC 130, detects conveyance of a sheet, and scans the sheet with the image reader 310. The image reader 310 stores the scanned image in the RAM 303 of the inspection apparatus 110. The inspection processor 305 executes inspection based on the inspection parameters set in the step S403. The inspection processor 305 executes the inspection using an image that obtained by reading the printed sheet for inspection and the correct answer image registered in the step S401.

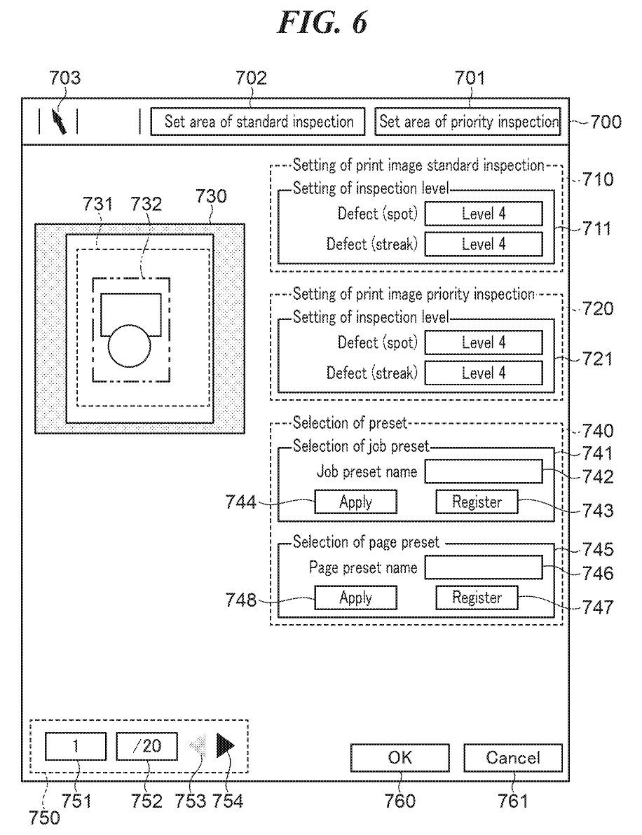

An example of a UI used in the inspection setting in the step S403 in FIG. 4 is described using FIG. 6. A UI screen 700 illustrated in FIG. 6 is displayed on the UI unit 320 of the inspection apparatus 110 at a timing of setting regarding the inspection in the step S403. A button 701 is pressed by the user when setting the priority inspection area. A button 702 is pressed by the user when setting the standard inspection area. A button 703 is a selection button of the inspection area. The button 703 is pressed by the user when the user wants to change setting of the inspection area that has already been set.

A page preview 730 is a display screen that displays the correct answer image read in the step S401. A UI 750 is displayed when a job is composed of a plurality of pages. The UI 750 is a UI group for switching the correct answer image page and the inspection items. A UI 751 displays a current page number, and a UI 752 displays a total page number. A button 753 is pressed by the user to switch the page preview 730 to a previous page. A button 754 is pressed by the user to switch the page preview 730 to a next page. A button 760 receives completion of the inspection setting. When the button 760 is pressed, the input set values are stored. Further, when the button 760 is pressed, inspection is executed. A button 761 is pressed by the user to cancel the inspection setting. When the button 761 is pressed, the input set vales are discarded and the inspection setting is terminated.

A UI 710 is a group for setting inspection levels of an abnormal image (a defect) to be detected in the standard inspection. A UI 720 is a group for setting inspection levels of an abnormal image (a defect) to be detected in the priority inspection. The UI 740 is a group of UIs for controlling use of a preset of the inspection configuration. The UI 740 includes a UI 741 for selecting a job preset and a UI 745 for selecting a page preset. The UI 741 includes a name box 742 in which a job preset name is selected, an apply button 744 for applying the selected job preset, and a register button 743 for registering the job preset. The UI 745 includes a name box 746 in which a page preset name is selected, an apply button 748 for applying the selected page preset, and a register button 747 for registering the page preset.

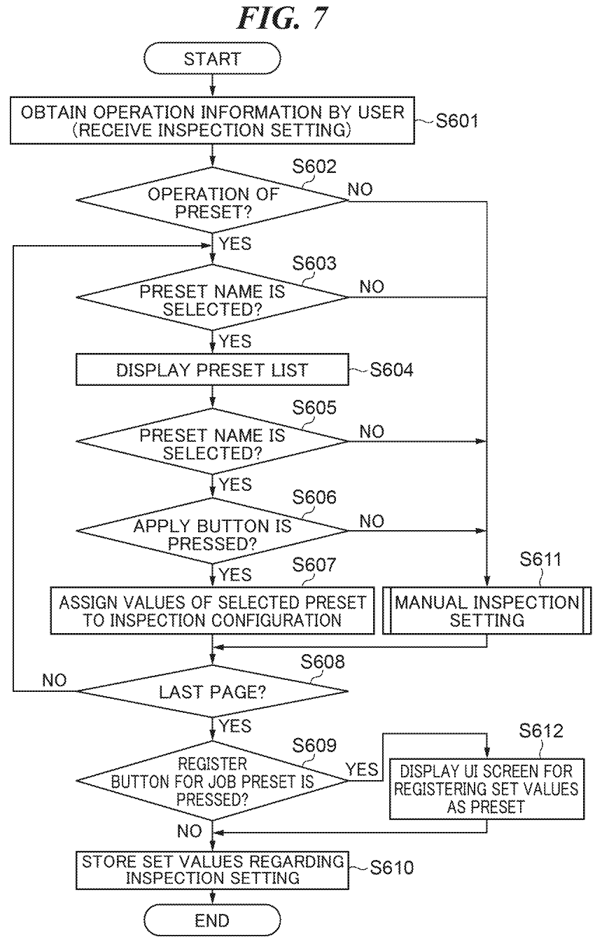

Next, a flow of an inspection setting process is described using a flowchart illustrated in FIG. 7. The flow of the inspection setting is a subroutine of the inspection setting in the step S403 in FIG. 4. In the inspection setting, a registered job preset or a registered page preset is selected. Further, in the inspection setting, set values may be manually input without using the job preset nor the page preset. Note that, in the description of FIG. 7, the presets shall include both the job presets in FIG. 5A and the page presets in FIG. 5B.

First, in a step S601, the inspection apparatus 110 obtains operation information about the inspection setting operation by the user who operates the UI 700. The operation information in the present embodiment regards to an operation of the job preset or the page preset, an operation of settings of the print image inspection, an operation of the inspection area, or an operation of area selection.

Then, in a step S602, the inspection apparatus 110 determines whether the operation information obtained in the step S601 regards to an operation of the preset in the UI 740. When the operation information regards to the operation of the preset in the UI 740 (YES in the step S602), the process proceeds to a step S603. On the other hand, when it does not regard to the operation of the preset (NO in the step S602), the process proceeds to a step S611.

In the step S603, the inspection apparatus 110 determines whether the job preset name in the UI 741 or the page preset name in the UI 745 is selected. When the preset name is selected (YES in the step S603), the process proceeds to a step S604. On the other hand, when the preset name is not selected (NO in the step S603, the process proceeds to the step S611.

In the step S604, the inspection apparatus 110 displays the preset names of the stored presets (FIGS. 5A or 5B) as a pull-down list. The inspection apparatus 110 displays, for example, the page presets 1 to 4. The preset name is displayed in, for example, the name box 742 or the name box 746 in FIG. 6.

Then, in a step S605, the inspection apparatus 110 determines whether a preset name is selected from the list of the preset names displayed in the step S604. When no preset name is selected (NO in the step S605), the process proceeds to the step S611. On the other hand, when the preset name is selected (YES in the step S605), the process proceeds to a step S606.

In the step S606, the inspection apparatus 110 determines whether the apply button 744 or 748 is pressed by the user operation. When the apply button is pressed (YES in the step S606), the process proceeds to a step S607. On the other hand, when the apply button is not pressed (NO in the step S606), the process proceeds to the step S611. Note that the case where the apply button is not pressed corresponds to a case where the operation regarding the inspection area or the area selection is executed.

In the step S607, the inspection apparatus 110 assigns the values set in the preset (FIGS. 5A or 5B) corresponding to the preset name selected in the step S605 to the inspection configuration used for inspection. Then, in a step S608, the inspection apparatus 110 determines whether the inspection setting is performed up to a final page of the print job. When the inspection setting is performed up to the final page (YES in the step S608), the process proceeds to a step S609. On the other hand, when the inspection setting is not performed up to the final page (NO in the step S608), the process returns to the step S603. Note that the case where the inspection setting is not performed up to the final page corresponds to a case where an operation of the button 751, 752, 753, or 754 is received. When the operation of the button 751, 752, 753, or 754 is received, the inspection apparatus 110 displays a page corresponding the operated button.

In the step S609, the inspection apparatus 110 determines whether the register button 743 of the job preset is pressed by the user operation. When the register button 743 is pressed (YES in the step S609), the process proceeds to a step S612. On the other hand, when the register button 743 is not pressed (NO in the step S609), the process proceeds to a step S610. Here, it is determined whether to register the job preset of the entire print job (see FIG. 5A).

In the step S610, the inspection apparatus 110 stores the set values regarding the inspection setting input up to now. Thereby, the process of this flow is terminated.

In the step S611, the inspection apparatus 110 executes the inspection setting manually without using any presets. Then, the process proceeds to the step S608.

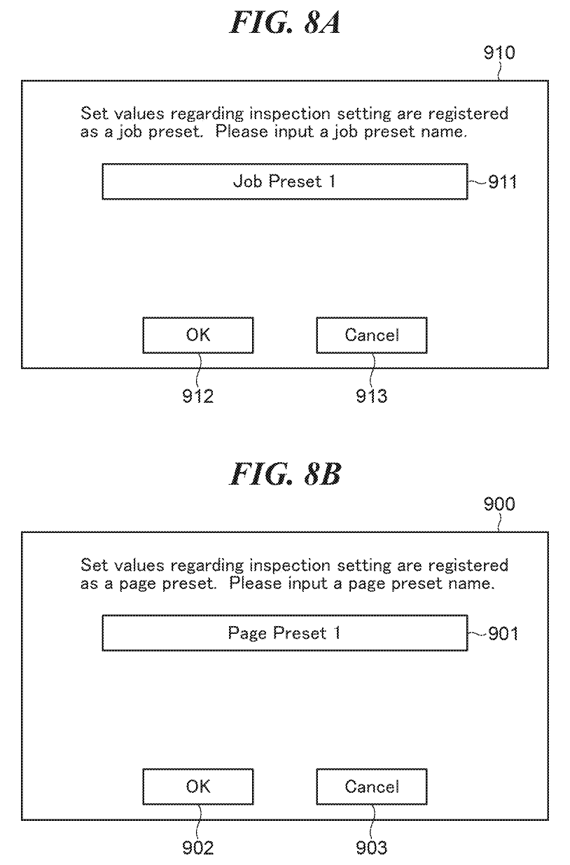

In the step S612, the inspection apparatus 110 displays a UI screen for registering the set values regarding the inspection setting as a preset. A UI screen 910 in FIG. 8A is displayed on the UI unit 320 of the inspection apparatus 110 at a timing of registering in the set values as the preset in the step S612. A text box 911 is pressed by the user when registering the job preset. The user can set a character string to be registered as a job preset name in the text box 911. The text box 911 is a UI that receives direct input using a keyboard.

An OK button 912 is used to register and store the job preset. When the OK button 912 is pressed, the character string input into the text box 911 is stored as the job preset name of the preset. Further, when the OK button 912 is pressed, the set values are stored in the job preset. The preset is stored in a storage unit (not shown).

A cancel button 913 is used to interrupt registration of a preset. When the cancel button 913 is pressed by the user, the set values that were intended to be registered as a preset are discarded. Further, the process of registering the job preset is terminated. After that, the process proceeds to the step S610. Note that the setting regarding the print image inspection during the setting operation by the user in FIG. 7 can be adjusted again even after the setting.

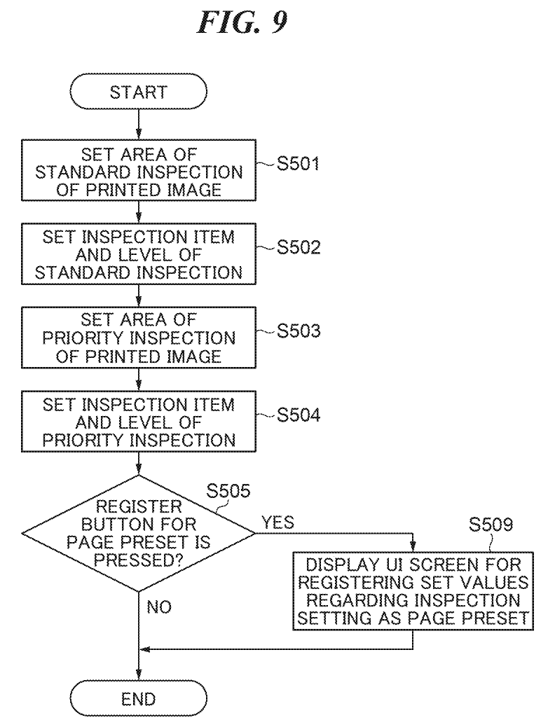

Next, a flow of the step S611 for performing the manual inspection setting is described using FIG. 9. The inspection apparatus 110 sets various types of inspection parameters such as an inspection area and an inspection level regarding the print image inspection for each correct answer image page in accordance with the inspection setting operation by the user.

First, in a step S501, the inspection apparatus 110 sets an area of the standard inspection of a printed image in accordance with the inspection setting operation by the user. When the user presses the button 702, the user is allowed to set the standard inspection area. An area subjected to the standard inspection is specified in the page preview 730 by the user operation. The inspection apparatus 110 sets a corresponding specified area as a standard inspection area 731.

Then, in a step S502, the inspection apparatus 110 sets inspection items for inspecting an abnormal image and their inspection levels in the standard inspection in accordance with the inspection setting operation in a UI 711 (FIG. 6) by the user. The inspection items of the standard inspection are features of abnormal images that are desired to be detected when the printed matter is inspected. The inspection items are, for example, a round-shaped abnormal image (a spot) and a linear abnormal image (a streak). The inspection level is a parameter that is set for each feature of the abnormal image in five stages from level 1 to level 5. The inspection level indicates a size of the abnormal image that is determined as a defect. For example, the larger the inspection level is, the thinner and smaller the abnormal image determined as a defect. Further, the inspection level can be set for each inspection item. For example, the inspection level of a spot can be level 3 and that of a streak can be level 4. In the UI 711, it is shown that the inspection level of the abnormal image (a spot) is level 4 and the inspection level of the abnormal image (a streak) is also level 4, which are selected by the user.

Then, in a step S503, the inspection apparatus 110 sets an area of the priority inspection in accordance with the inspection setting operation by the user. When the user presses the button 701, the user is allowed to set the priority inspection area. An area subjected to the priority inspection is specified in the page preview 730 by the user operation. The inspection apparatus 110 sets a corresponding specified area as a priority inspection area 732.

Then, in a step S504, the inspection apparatus 110 sets inspection items for inspecting an abnormal image and their inspection levels in the priority inspection in accordance with the inspection setting operation in a UI 721 by the user. In the UI 721, it is shown that the inspection level of the abnormal image (a spot) is level 4 and the inspection level of the abnormal image (the streak) is also level 4, which are selected by the user.

Then, in a step S505, the inspection apparatus 110 determines whether the register button 747 for the page preset is pressed by the user operation. When the register button 747 is pressed (YES in the step S505), the process proceeds to a step S509. On the other hand, when the register button is not pressed (NO in the step S505), the process by this flow is terminated.

In the step S509, the inspection apparatus 110 displays a UI screen for registering the set values regarding the inspection setting as the page preset. An example of the UI screen regarding registration as the page preset is described using FIG. 8B. The page preset is obtained in the above-described step S402 and is set for each page included in the print job. The page preset is setting information that stores various types of inspection parameters, such as an inspection area and an inspection level, for each correct answer image page. A UI screen 900 shown in FIG. 8B is displayed on the UI unit 320 of the inspection apparatus 110 at a timing of registering the page preset in the step S509. A text box 901 is pressed by the user when registering the page preset. The user can set a character string to be registered as a page preset name in the text box 901. The text box 901 is a UI that receives direct input using a keyboard.

An OK button 902 is used to register and store the page preset. When the OK button 902 is pressed, the character string input into the text box 901 is stored as the page preset name of the page preset. Further, when the OK button 902 is pressed, the set values are stored in the page preset. The page preset is stored in the storage unit (not shown). A cancel button 903 is used to interrupt registration of a preset. When the cancel button 903 is pressed by the user, the set values that were intended to be registered as a preset are discarded. Further, the process of registering the page preset is terminated. Thereby, the process of this flow is terminated.

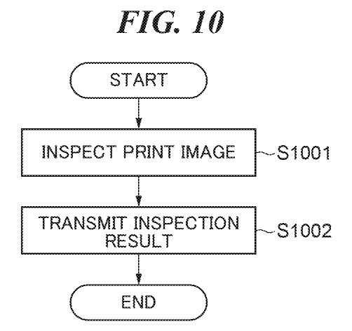

Next, an operation of the inspection execution process in the step S404 in FIG. 4 is described using a flowchart shown in FIG. 10. In the inspection apparatus 110, the inspection processor 305 executes inspection when the user presses an inspection start button (not shown) displayed on the UI unit 320 as a trigger.

First, in a step S1001, the inspection processor 305 detects the abnormal image (the spot) and the abnormal image (the streak) included in the printed matter as the abnormal images when printing. The inspection processor 305 detects the abnormal images based on the inspection configuration set by the user in the step S404. An abnormal image detection method when printing in the present embodiment includes a step of extracting a difference image between the correct answer image registered in the step S402 and the scanned image of the print job corresponding to the correct answer image. Further, the abnormal image detection method includes a step of detecting the abnormal image (the spot) and the abnormal image (the streak) from features in the extracted difference image. Note that a publicly known technique may be used as the abnormal image detection method when printing.

Then, in a step S1002, the inspection processor 305 transmits an inspection result obtained in the step S1001 to the UI unit 320. When receiving the inspection result, the UI unit 320 displays the scanned image of the inspection target and the inspection result to the user. When the printed matter includes the abnormal image, the UI unit 320 emphasizes the detected abnormal image with a dotted line frame or a color frame put on the scanned image. The UI unit 320 also displays the type (the spot, the streak, etc.) and the position of the detected abnormal image together. When the printed matter includes no abnormal image, the UI unit 320 displays a character string that indicates there is no abnormal image. The method of displaying the inspection result by the UI unit 320 is not limited to them, and may be any method that can clearly display the detection result to the user.

Further, the inspection processor 305 transmits the inspection result obtained in the step S1001 to the image forming apparatus 100 and the finisher 120. Note that the information (the inspection result) transmitted to the image forming apparatus 100 indicates that a predetermined number of the printed sheets with the abnormal images occur continuously. The information (the inspection result) transmitted to the finisher 120 indicates whether the printed matter includes the abnormal image. As described above, when the image forming apparatus 100 receives the above information, it stops the printing operation. Further, the finisher 120 discharges the printed sheet without the abnormal image to the normal sheet discharge tray using the received information. On the other hand, the finisher 120 discharges the printed sheet with the abnormal image to a tray that is different from the normal sheet discharge tray. According to the present embodiment, the user enables efficient setting by using the registered page preset while reducing inputs of set values required for inspection.

In the first embodiment, as shown in FIG. 5C, a page preset name may be registered as a name that represents a layout feature (a page type) of a page defined in the correct answer image data. The page preset name may be, for example, an outside front cover, an inside front cover, an index, an inside back cover, or an outside back cover. Thereby, it becomes easier to find the preset to be set when selecting a page preset name in the step S605. Therefore, simpler and more efficient selection of the preset becomes possible.

The correct answer image is not limited to an image scanned with the image reader 310. The correct answer image data may be, for example, a bitmapped image obtained by performing an RIP process for the print data or the document data. In such a case, the image processor 205 that is capable of performing the RIP process may be provided in the inspection apparatus 110.

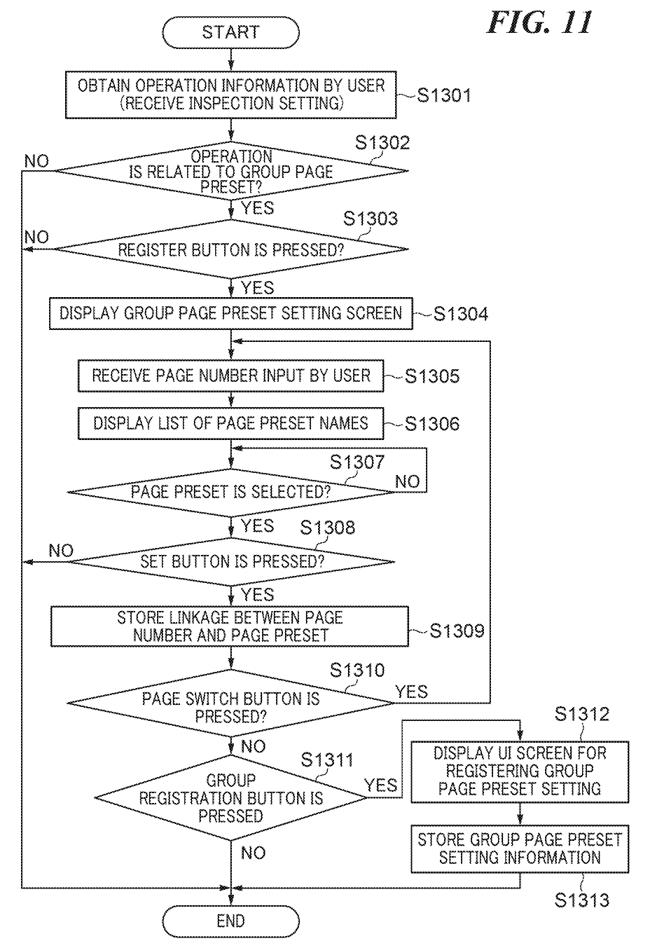

Next, a second embodiment of the present disclosure will be described with reference to FIGS. 11-15. In the second embodiment, an example of grouping page presets, which are inspection configurations in units of pages, and registering a combination of the inspection configurations will be described.

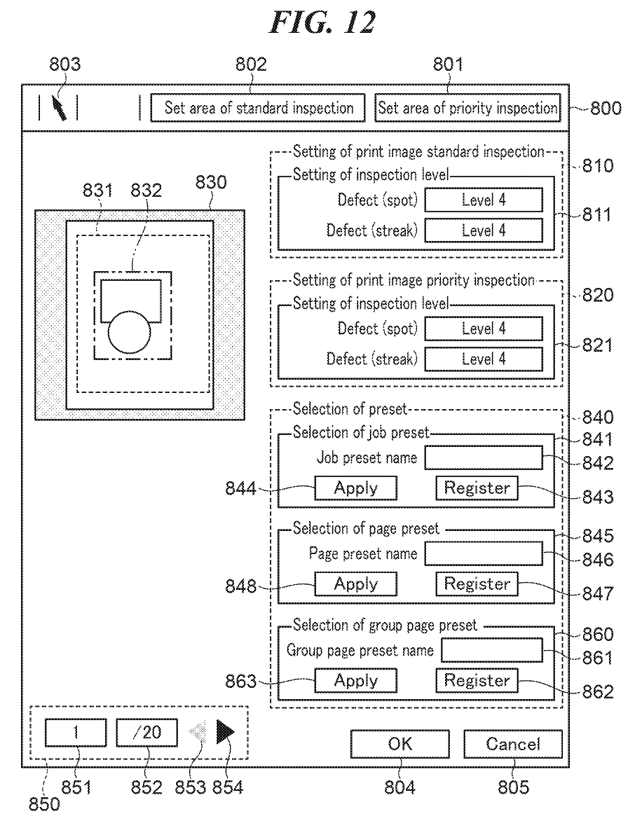

FIG. 11 is a flowchart illustrating a flow of a process of grouping and registering page presets. Further, FIG. 12 is a view illustrating a screen displayed when grouping and registering page presets. First, in a step S1301, the inspection apparatus 110 obtains operation information about the inspection setting operation by the user who operates a UI 800. The operation information is related to an operation of a job preset, a page preset, or a group page preset. Further, the operation information is related to an operation to set a standard inspection area or a priority inspection area, an operation to set an inspection level, or the like. Note that a button 801 to a button 854 in FIG. 12 respectively correspond to the button 701 to the button 754 in FIG. 6, and thus descriptions are omitted.

Next, in a step S1302, the inspection apparatus 110 determines whether the operation information obtained in the step S1301 is related to an operation to a UI 860 for selecting a group page preset. When it is determined that the operation is related to the selection of the group page preset (YES in the step S1302), the process proceeds to a step S1303. On the other hand, when it is determined that the operation is not related to the group page preset (NO in the step S1302), the process of this flow is terminated.

In the step S1303, the inspection apparatus 110 determines whether a register button 862 of the group page preset is pressed by the user operation. When the register button 862 is pressed (YES in the step S1303), the process proceeds to a step S1304. On the other hand, when the register button 862 is not pressed (NO in the step S1303), the process of this flow is terminated.

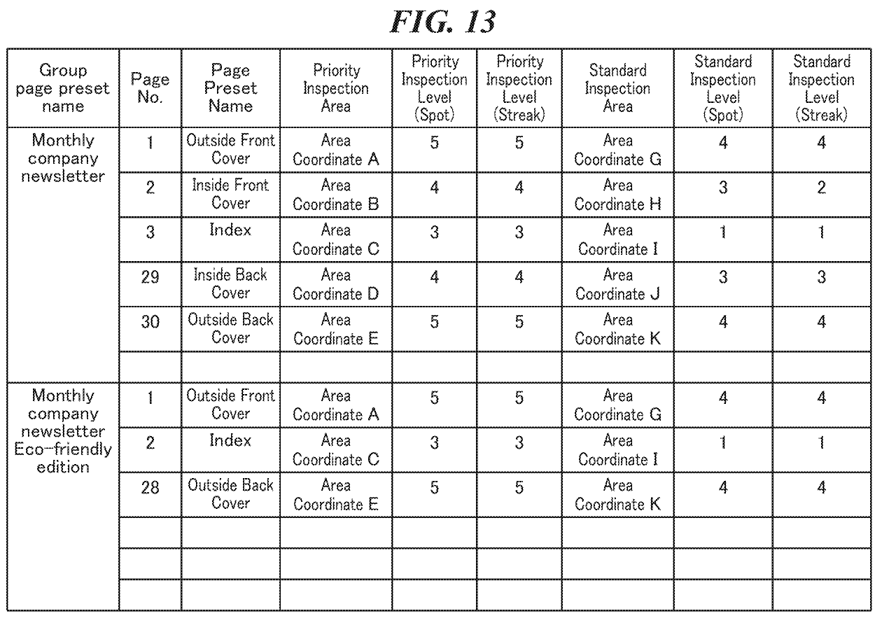

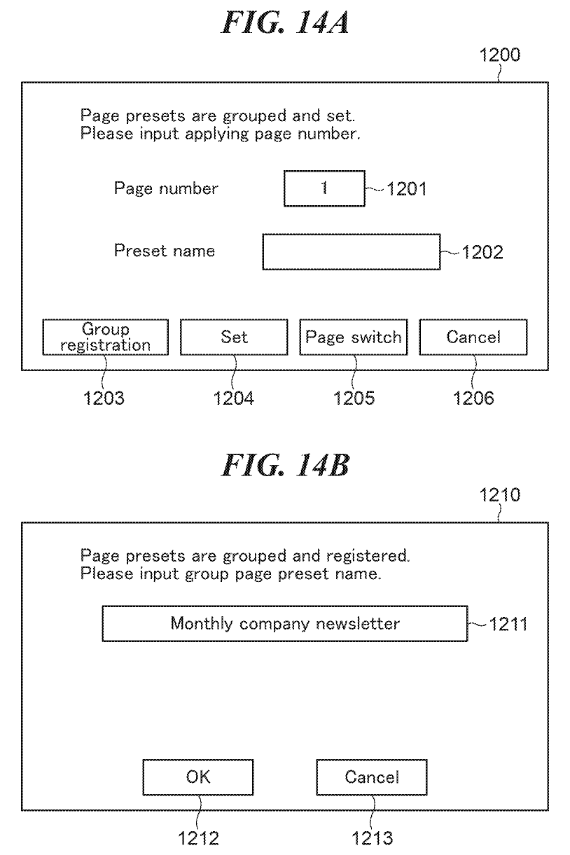

In the step S1304, the inspection apparatus 110 displays a UI for setting and registering the group page preset (a group page preset setting screen). Setting information of the group page preset is described using FIG. 13. And examples of the UI regarding the group page preset are described using FIGS. 14A and 14B.

A group page preset table shown in FIG. 13 links inspection target page numbers to page presets and stores them together as a group. The group page preset table stores group page presets, each of which includes a group page preset name, inspection target page numbers, page preset names, priority inspection areas, priority inspection levels (a spot and a streak), standard inspection areas, and standard inspection levels (a spot and streak). The group page preset name is a set value that serves as a display name when the group page presets are displayed as a list on the UI 860. The group page preset name is input in a text box 1211 of a UI screen 1210 shown in FIG. 14B when registering the group page preset name.

A UI screen 1200 shown in FIG. 14A is displayed on the UI unit 320 of the inspection apparatus 110 in the step S1304. A text box 1201 is used to input the inspection target page number when setting the group page preset. The text box 1201 receives direct input using a keyboard. A box 1202 is a display area for displaying the page preset name to be linked with the inspection target page number. In the box 1202, registered page preset names are displayed as a list in a selectable manner.

A group registration button 1203 is used to register the page number input into the text box 1201 and the page preset name displayed in the box 1202 as the selected group page preset. A set button 1204 is used to set and store the page number input into the text box 1201 and the page preset name displayed in the box 1202 as the selected group page preset. A page switch button 1205 is used to change the inspection target page. A cancel button 1206 is used to interrupt the setting. When the cancel button 1206 is pressed by the user, the values being set are discarded. Further, the group registration is terminated.

Returning to FIG. 11, in a step S1305, the inspection apparatus 110 receives the inspection target page number input into the text box 1201 by the user operation. Then, in a step S1306, the inspection apparatus 110 displays the page preset names read from the stored page presets (FIGS. 5B or 5C) as a pull-down list.

Then, in a step S1307, the inspection apparatus 110 determines whether the page preset is selected from the list of the page preset names displayed in the step S1306. When the page preset is selected (YES in the step S1307), the process proceeds to a step S1308. On the other hand, when the page preset is not selected (NO in the step S1307), the step S1307 is repeated.

In the step S1308, the inspection apparatus 110 determines whether the set button 1204 is pressed by the user operation. When the set button is pressed (YES in the step S1308), the process proceeds to a step S1309. On the other hand, when the set button 1204 is not pressed (NO in the step S1308), the process of this flow is terminated.

In the step S1309, the inspection apparatus 110 stores a linkage between the input page number and the selected page preset. Then, in a step S1310, the inspection apparatus 110 determines whether the page switch button 1205 is pressed by the user operation. When the page switch button 1205 is pressed (YES in the step S1310), the process proceeds to the step S1305. On the other hand, when the page switch button 1205 is not pressed (NO in the step S1310), the process proceeds to a step S1311.

In the step S1311, the inspection apparatus 110 determines whether the group registration button 1203 is pressed by the user operation. When the group registration button 1203 is pressed (YES in the step S1311), the process proceeds to a step S1312. On the other hand, when the group registration button 1203 is not pressed (NO in the step S1311), the process of this flow is terminated.

In the step S1312, the inspection apparatus 110 displays a UI screen to register the group page preset. An example of the UI screen regarding registration of the group page preset is described using FIG. 14B.

The UI screen 1210 shown in FIG. 14B is displayed on the UI unit 320 of the inspection apparatus 110 when registering the group page preset in the step S1312. The text box 1211 is pressed by the user when setting a character string to be registered as the page preset name. The text box 1211 receives direct input using a keyboard.

An OK button 1212 is used to register and store the group page preset where the character string input into the text box 1211 is set as the group page preset name. A cancel button 1213 is used to interrupt the group page preset registration. When the cancel button 1213 is pressed, values being set that were intended to be subjected to the group page preset registration is discarded. Thereby, the registration of the group page preset is terminated.

In a step S1313, the inspection apparatus 110 stores the group page preset. The inspection apparatus 110 stores all of the linkages between the page numbers and the page presets stored in the step S1309. The inspection apparatus 110 stores it as the group page preset (see FIG. 13) using the group page preset name input into the text box 1211.

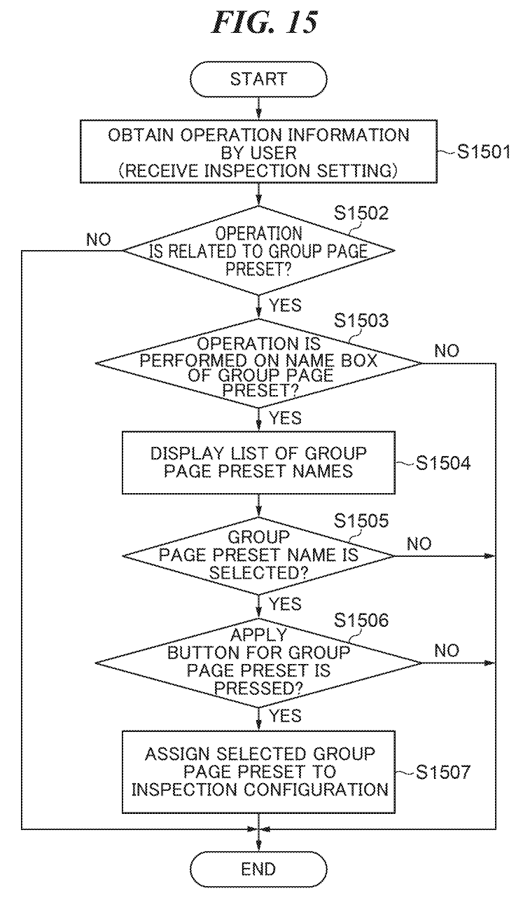

Next, a process in a case where a registered group page preset that has been subjected to the group registration is used will be described using FIG. 15. Steps S1501 and S1502 in FIG. 15 are the same operations as in the steps S1301 and S1302 in FIG. 11, and thus descriptions are omitted.

In the step S1502, the inspection apparatus 110 determines whether the operation is related to the group page preset. When the operation is related to the group page preset (YES in the step S1502), the process proceeds to a step S1503. On the other hand, when the operation is not related to the group page preset (NO in the step S1502), the process of this flow is terminated.

In the step S1503, the inspection apparatus 110 determines whether the operation is performed on a name box 861 in which a group page preset name is selected. When the operation is performed on the name box 861 (YES in the step S1503), the process proceeds to a step S1504. On the other hand, when the operation is not performed on the name box (NO in the step S1503), the process of this flow is terminated.

In the step S1504, the inspection apparatus 110 displays the group page preset names read from the stored group page presets (FIG. 13) as a pull-down list. The group page preset names are displayed in, for example, the name box 861 in FIG. 12.

Then, in a step S1505, the inspection apparatus 110 determines whether a group page preset is selected based on whether a group page preset name is selected from the list of the group page preset names displayed in the step S1504. When the group page preset is selected (YES in the step S1505), the process proceeds to a step S1506. On the other hand, when no group page preset is selected (NO in the step S1505), the process of this flow is terminated.

In the step S1506, the inspection apparatus 110 determines whether an apply button 863 for applying the group page preset is pressed by the user operation. When the apply button 863 is pressed (YES in the step S1506), the process proceeds to a step S1507. On the other hand, when the apply button 863 is not pressed (NO in the step S1506), the process of this flow is terminated.

In the step S1507, the inspection apparatus 110 reads the group page preset (see FIG. 13) that corresponds to the group page preset name selected in the step S1505. The inspection apparatus 110 assigns the inspection configuration of the page number that is included in the read group page preset as the inspection configuration of the corresponding page number. According to the second embodiment, the page preset, which is the inspection configuration in units of pages, and an inspection target page can be linked and grouped and stored as a combination of inspection configurations. Therefore, the user enables more efficient setting while reducing inputs of set values required for inspection.

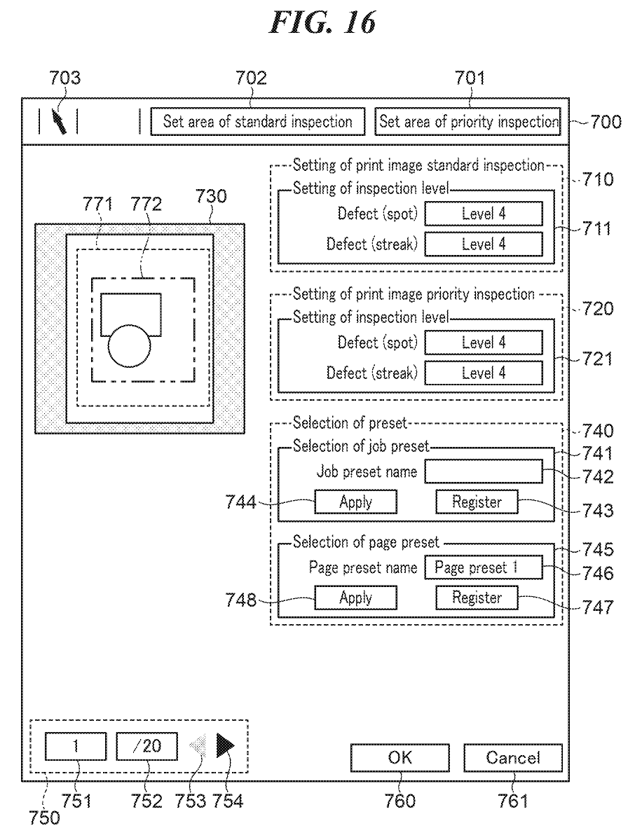

Next, a third embodiment of the present disclosure is described with reference to FIG. 16. In the third embodiment, when a preset is selected, the inspection apparatus 110 displays an area that is inspected by the selected preset.

FIG. 16 is a view illustrating a screen displayed when a page preset is selected. FIG. 16 shows a case where the page preset 1 is selected as shown in the name box 746. When the page preset 1 is selected, a standard inspection area 771 and a priority inspection area 772 are displayed. Thereby, the standard inspection area and the priority inspection area of the page preset 1 can be easily confirmed.

Note that the inspection apparatus 110 may change the standard inspection area 771 and the priority inspection area 772 by a manual operation. For example, when one side of the standard inspection area 771 is selected and moved on the screen, the inspection apparatus 110 may change the standard inspection area according to the movement. Further, when one side of the priority inspection area 772 is selected and moved on the screen, the inspection apparatus 110 may change the priority inspection area 772 according to the movement. Note that the method to change the standard inspection area 771 and the priority inspection area 772 is not limited to the movement of one side, and the area may be enlarged or reduced by selecting and moving a corner. Further, when the standard inspection area 711 and the priority inspection area 722 are set manually, each area may be displayed on the screen.

Further, a plurality of standard inspection areas and a plurality of priority inspection areas may be set. Further, the inspection processor 305 may reflect changed contents to a job preset or a page preset used for inspection. The inspection processor 305 may execute inspection using the job preset or the page preset to which the changed contents are reflected. Further, in FIG. 16, the inspection apparatus 110 may also display inspection levels for a spot and a streak (inspection contents) that are included in the selected job preset or the selected page preset and set for the standard inspection area and the priority inspection area.

Although the registered preset is obtained in the step S402 in FIG. 4 (obtaining the preset) in the above embodiment, this is not limited. The preset may be obtained at a time of selecting a preset area in the step S602 in FIG. 7.

Further, although the process is terminated when it is determined that the setting is not performed in the step S1308 in the second embodiment, this is not limited. When it is determined that the setting is not performed in the step S1308 and the page switch button 1205 is pressed, the process may return to the step S1305.

According to the present disclosure, it is possible to provide a mechanism that enables efficiency improvement of the inspection setting operation.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-081447, filed May 14, 2025, which is hereby incorporated by reference herein in its entirety.

What is claimed is:

1. An inspection apparatus that inspects a printing state of printed matter obtained by printing document data, the inspection apparatus comprising:
an image reader configured to read the printed matter and generate a scanned image;
a memory device that stores a set of instructions; and
at least one processor that executes the set of instructions to:
obtain presets each of which includes a combination of an area to be inspected in the scanned image and an inspection content;
receive a selection of a preset to be used for inspection of the scanned image from among the presets obtained; and
execute inspection of the scanned image according to the preset selected.

2. The inspection apparatus according to claim 1, wherein the at least one processor executes instructions in the memory device to obtain the presets each of which includes the combination of the area and the inspection content for each page of the printed matter.

3. The inspection apparatus according to claim 2, wherein the at least one processor executes instructions in the memory device to obtain the presets each of which includes the combination of the area and the inspection content set for each page type of the printed matter.

4. The inspection apparatus according to claim 2, wherein the at least one processor executes instructions in the memory device to register the presets each of which includes the combination of the area and the inspection content for each page of the printed matter.

5. The inspection apparatus according to claim 4, wherein the at least one processor executes instructions in the memory device to register the presets each of which includes the combination of the area and the inspection content set for each page type of the printed matter.

6. The inspection apparatus according to claim 1, further comprising a display unit configured to display the area and the inspection content set by the preset selected.

7. The inspection apparatus according to claim 6, wherein in the at least one processor executes instructions in the memory device to:
receive a change of the area and the inspection content displayed on the display unit; and
reflect the changed contents to the preset used for the inspection.

8. An inspection method to inspect a printing state of printed matter obtained by printing document data, the inspection method comprising:
generating a scanned image by reading the printed matter;
obtaining presets each of which includes a combination of an area to be inspected in the scanned image and an inspection content;
receiving a selection of a preset to be used for inspection of the scanned image from among the presets obtained; and
executing inspection of the scanned image according to the preset selected.

9. A non-transitory computer-readable storage medium storing an inspection program causing a computer to execute an inspection method to inspect a printing state of printed matter obtained by printing document data, the inspection method comprising:
generating a scanned image by reading the printed matter;
obtaining presets each of which includes a combination of an area to be inspected in the scanned image and an inspection content;
receiving a selection of a preset to be used for inspection of the scanned image from among the presets obtained; and
executing inspection of the scanned image according to the preset selected.
